(19) United States
(12) Patent Application Publication
(10) Pub. No.: US 2016/0247099 A1
(43) Pub. Date: Aug. 25, 2016

(54) DYNAMIC TRAVEL EXPENSE OPTIMIZATION

(71) Applicant: International Business Machines Corporation, Armonk, NY (US)

(72) Inventors: John V. Delaney, Meath (IE); Mickey Iqbal, Plano, TX (US); Nadeem Malik, Austin, TX (US); Clea A. Zolotow, Key West, FL (US)

(21) Appl. No.: 14/626,470

(22) Filed: Feb. 19, 2015

(51) Int. Cl. G06Q 10/02; G06Q 50/14; G01C 21/34

(52) U.S. Cl. CPC G06Q 10/025; G01C 21/34; G06Q 50/14

(57) ABSTRACT

Embodiments of the present invention provide systems and methods for optimizing travel expenses. The method includes mining data types for a set of planned travel parameters and transposing the mined data types into a set of variables. The method includes performing a constraint-based optimization and a genetic algorithm on the set of variables and generating a list of travel options.

### BACKGROUND OF THE INVENTION

The present invention relates generally to the field of online travel reservations, and more particularly to dynamically optimizing employee business travel expenses based on real-time information.

Particular organizations often implement a business travel policy for the employees, in order to set rules and guidelines for the employees when making business travel plans. These business travel policies often factor in direct costs, such as air fare and hotel expenses. The business travel polices often allow an employee to use the travel options which provide the overall lowest cost to the employer. In some organizations, if an employee wants to implement a travel option outside of the approved travel policy, the employee must provide a justification for the exception to a manager, who must then subsequently approve the exception.

### SUMMARY

According to one embodiment of the present invention, a method for travel expense optimization is provided, the method comprising: for a set of planned travel parameters, mining, by an analytics engine, a plurality of data types; transposing, by the analytics engine, the plurality of data types into a set of variables; performing, by the analytics engine, a constraint-based optimization, wherein the constraint-based optimization comprises more than one constraint; performing, by one or more processors, a genetic algorithm, wherein the genetic algorithm is based, at least in part, on a plurality of data from one or more media feeds; and generating, by the analytics engine, a list of travel options, wherein the list of travel options is based, at least in part, on results associated with the constraint-based optimization and results associated with the genetic algorithm.

### BRIEF DESCRIPTION OF THE DRAWINGS

FIG. 1 is a functional block diagram illustrating a data processing environment, in accordance with an embodiment of the present invention;

FIG. 2A is a flowchart illustrating operational steps for dynamically determining a set of optimized travel costs, in accordance with an embodiment of the present invention;

FIG. 2B is a flowchart illustrating operational steps for performing a constraint-based optimization on a set of variables, in accordance with an embodiment of the present invention;

FIG. 2C is a flowchart illustrating operational steps for performing a genetic algorithm on a set of variables, in accordance with an embodiment of the present invention; and

FIG. 3 is a block diagram of internal and external components of the computing device of FIG. 1, in accordance with an embodiment of the present invention.

### DETAILED DESCRIPTION

Many organizations have a pre-approved business travel policy for their employees, which calculates the lowest direct cost to an employer. However, the business travel policies do not account for factors such as the value of an employee's time and loyalty programs in which the employee may be enrolled. Embodiments of the present invention provide efficient and cost-effective systems and methods for dynamically optimizing the business travel expenses incurred by an employee, using employee travel preferences and real-time data provided by various social media feeds.

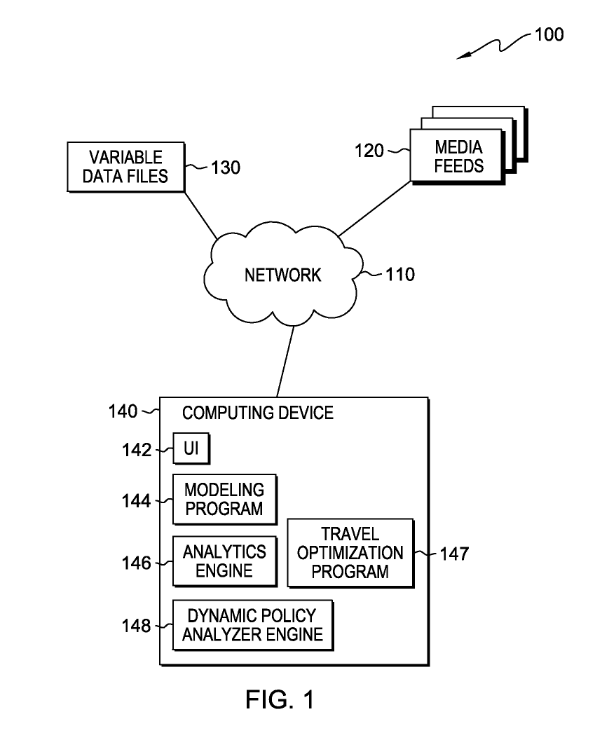

The present invention will now be described in detail with reference to the Figures. FIG. 1 is a functional block diagram illustrating a data processing environment, generally designated 100, in accordance with an embodiment of the present invention. Modifications to data processing environment 100 may be made by those skilled in the art without departing from the scope of the invention as recited by the claims. In an exemplary embodiment, data processing environment 100 includes media feeds 120, variable data files 130, and computing device 140, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication and/or access between media feeds 120, variable data files 130, and computing device 140.

Media feeds 120 receive information from media sources, such as social network services, online communities, and online news sources. Information received from media feeds 120 may include information associated with social networks, weather, news channels, print media, wikis, blogs, and one or more airline websites, among other information. Information gathered from media feeds 120 may subsequently be parsed into variable data files 130, accessed via network 110.

Variable data files 130 includes information detailing data gathered from various media feeds, such as media feeds 120. In this exemplary embodiment, variable data files 130 are stored remotely, such as on a server (not depicted) and may be accessed via network 110. In other embodiments, variable data files 130 may be stored locally, such as on computing device 140.

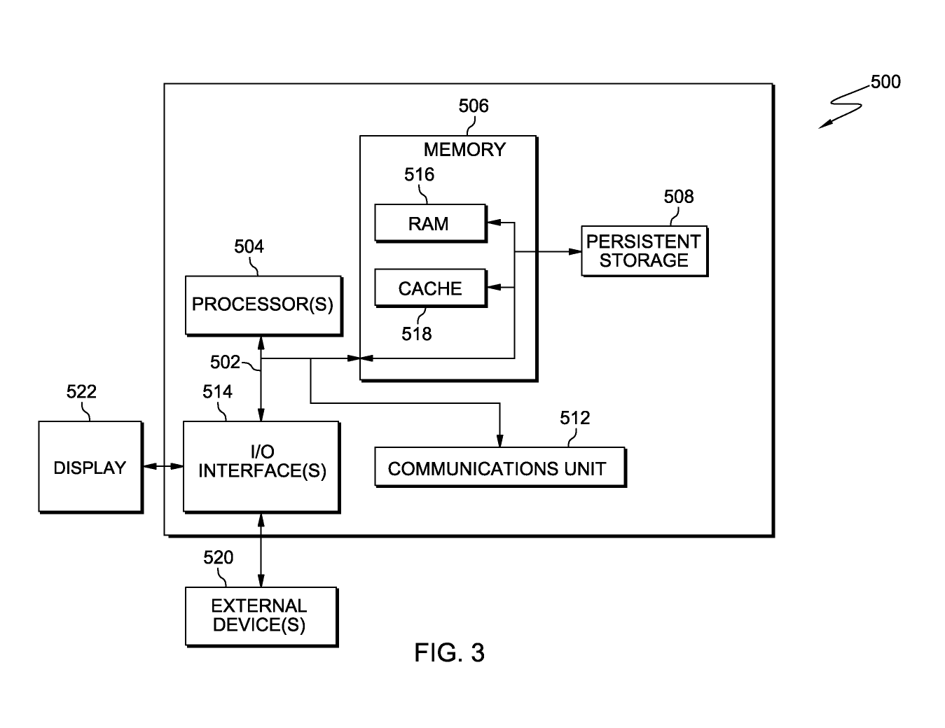

Computing device 140 includes user interface (UI) 142, modeling program 144, analytics engine 146, travel optimization program 147, and dynamic policy analyzer engine 148. In various embodiments of the present invention, computing device 140 can be a laptop computer, a tablet computer, a netbook computer, a personal computer (PC), a desktop computer, a personal digital assistant (PDA), a smart phone, a thin client, or any programmable electronic device capable of executing computer readable program instructions. Computing device 140 may include internal and external hardware components, as depicted and described in further detail with respect to FIG. 3.

UI 142 may be, for example, a graphical user interface (GUI) or a web user interface (WUI) and can display text, documents, web browser windows, user options, application interfaces, and instructions for operation, and includes the information (such as graphic, text, and sound) a program presents to a user and the control sequences the user employs to control the program. UI 142 is capable of receiving data, user commands, and data input modifications from a user. UI 142 is also capable of communicating with modeling program 144, analytics engine 146, travel optimization program 147, and dynamic policy analyzer engine 148.

Modeling program 144, in conjunction with UI 142, may provide an interface, which may be accessed by a user to run multiple variations of travel route optimizations, using a variety of different variables, input by a user.

Analytics engine 146 is a predictive analytics engine, which is capable of gathering, mining, and processing various types of data associated with travel cost determinations (e.g., membership in a loyalty program, employee travel trends, and social media data). Analytics engine 146 stores the travel policy rules associated with gathered data and is capable of adding and/or amending the travel policy rules, based on new gathered data (i.e., real-time data obtained from social media feeds).

Travel optimization program 147 is a software application capable of receiving information, such as variable data files 130. Although depicted as a separate component, in one embodiment, travel optimization program 147 may be partially or fully integrated with UI 142. In other embodiments, travel optimization program 147 is fully or partially integrated within an online travel reservation system or tool. In this exemplary embodiment, travel optimization program 147 is capable of retrieving information via network 110. Travel optimization program 147 is capable of receiving data from variable data files 130, performing a multiple constraint-based algorithm on the data, performing a genetic algorithm on the data, and calculating an optimized travel plan for a particular user, based on the preferences and information associated with the particular user.

Dynamic policy analyzer engine 148 is a rule-based inference engine and operates as a dynamic feedback loop to travel optimization program 147. Dynamic policy analyzer engine 148 is capable of approving travel exceptions based on inputs from multiple-data sources and is capable of adding additional rules to analytics engine 146, based on the results of a multiple constraint-based optimization calculation.

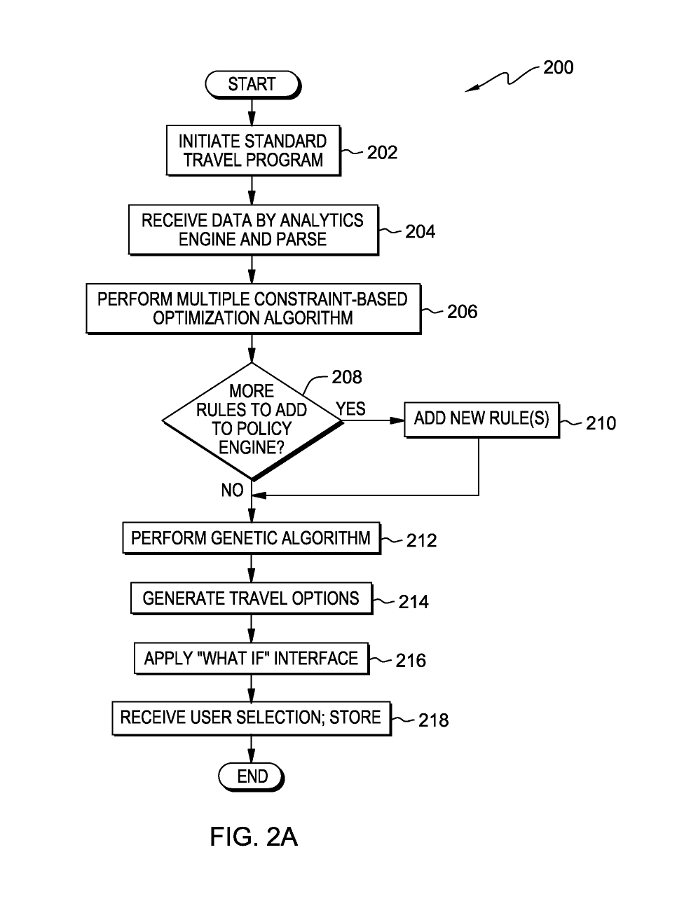

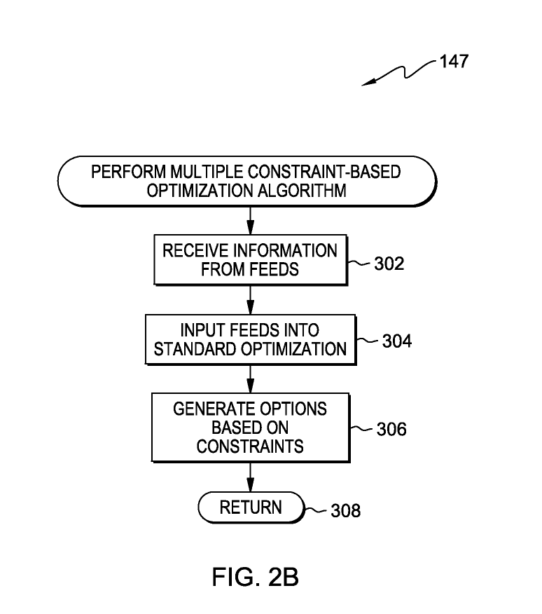

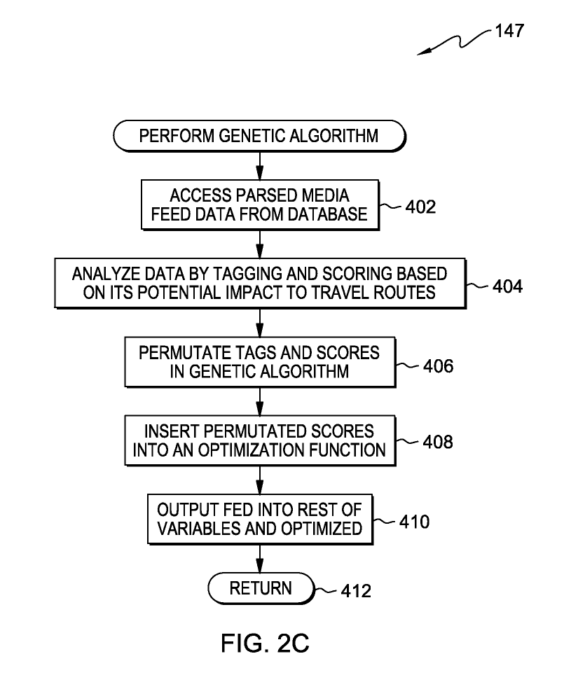

FIG. 2A is a flowchart 200 illustrating operational steps for dynamically determining a set of optimized travel costs, in accordance with an embodiment of the present invention.

In step 202, a standard travel program operating on a computing device is initiated by a user. The user may input a set of travel parameters relevant to the planned trip, and the standard travel program generates an initial set of travel expenses and which options are available to the user within the predefined business travel policy rules.

In step 204, analytics engine 146 receives a set of data from various feeds, such as media feeds 120, and other sources. The data received by analytics engine 146 is then processed and transposed by a standard parser, where the data is then categorized and encoded for future processing.

In step 206, the processed data from step 204 is fed into a multiple-constraint based optimization algorithm. In an embodiment, travel optimization program 147 invokes the multiple-constraint based algorithm of FIG. 2B (discussed below) to calculate the optimized travel options for a user, based on a set of constraints, chosen by a particular user.

In step 208, dynamic policy analyzer engine 148 is initiated by travel optimization program 147, which determines whether there are more rules to add to the travel policy database of analytics engine 146. One or more new rules may be added to the policy database, based on the results of the multiple constraint-based optimization algorithm (step 206).

If dynamic policy analyzer engine 148 determines that there are new rules to add, based on the results of the multiple-constraint based optimization algorithm, then, in step 210, the new rule(s) are added to the travel policy rules database of analytics engine 146.

If dynamic policy analyzer engine 148 determines that there are no new rules to add to the travel policy database of analytics engine 146 from the results of the multiple-constraint based optimization algorithm, then, in step 212, the genetic algorithm of FIG. 2C is implemented by travel optimization program 147 to calculate the optimized travel options for a user, ensuring that the variability in the data is accounted for in the output.

In step 214, travel optimization program 147 generates a list of travel options available to the user, based on the data calculated by the multiple-constraint based optimization (step 206) and the genetic algorithm (step 212). In this exemplary embodiment, a final list of optimized travel options for the user is generated from the results of the optimization calculations performed on the three outputs from the genetic algorithm (step 410 of FIG. 2C).

In step 216, modeling program 144 is executed by travel optimization program 147. In this exemplary embodiment, modeling program 144 runs multiple scenarios of travel cost optimization, including and excluding various subsets of data gathered by analytics engine 146. For example, a user may want to further generate a list of travel options from the original optimized output of options, which exclude all flights and/or travel routes which pass through Denver. In this exemplary embodiment, modeling program 144 saves the various scenarios calculated by a user to a database, as well as the user selections, for future analysis.

In step 218, travel optimization program 147 receives the final travel selection from the user. After the user has made a final travel selection from the generated options, the chosen option is saved to a database (not depicted in FIG. 1) and calculations may be performed on the final options for future travel optimization determinations.

FIG. 2B is a flowchart illustrating operational steps of travel optimization program 147 for performing a constraint-based optimization on a set of variables, in accordance with an embodiment of the present invention.

In step 302, information from detailed feeds, including a set of constraints, is received by travel optimization program 147. In this exemplary embodiment, both hard constraints (i.e., conditions which are required to be satisfied) and soft constraints (i.e., conditions with variable values which are penalized in the objective function) are determined from feed information. For example, a hard constraint may be a low raw cost and membership to a loyalty program. A soft constraint may be the travel preferences of an employee. Detailed feed information is used to generate a file containing the travel preferences (i.e., constraints) of a particular employee. For example, an employee may indicate favored airports (e.g., connection time is less than three hours), favored travel routes (e.g., southern routes in winter), least favored airports (e.g., Cincinnati), and favorite amenities (e.g., only airports with a favored restaurant). Other soft constraints that may be factored in are the role of the employee within a company (e.g., dealing with an important transaction or interfacing with a customer) and the rate of pay of the employee (e.g., the employee time cost per hour). Another soft constraint which may be factored into the multi-constraint optimization algorithm is the historical travel trends of an employee (e.g., trend of reschedules for a particular employee, trend of violations of travel policy for a particular employee, and a trend of rescheduling by an account). For example, an employee who often requests a reschedule of their flight may be allowed to buy a refundable ticket, an exception to a company travel policy, which may help to save the employee's company money if they do not have to purchase a second ticket when the employee reschedules their flight.

In step 304, after the constraints from the detailed feeds are received, travel optimization program 147 inputs the information into a multi-constraint based optimization calculation. The multi-constraint based optimization calculation implements both hard and soft constraints and is based on a standard constrained optimization problem (i.e., the process of optimizing an objective function with respect to some variables in the presence of constraints on those variables).

In step 306, from the multi-constraint optimization calculation, travel optimization program 147 generates a list of optimized travel options, based on the input constraints (i.e., that information received in step 302). After the optimized travel options list is generated, in step 308, the subroutine returns to step 208 in FIG. 2A.

FIG. 2C is a flowchart illustrating the operational steps of travel optimization program 147 for performing a genetic algorithm on a set of variables, in accordance with an embodiment of the present invention.

In step 402, travel optimization program 147 accesses the data which has been received and parsed by a standard parser. For example, travel optimization program 147 may receive data that has been parsed from social networking sites, blogs, and/or news sites (i.e., media feeds 120).

In step 404, travel optimization program 147 analyzes the parsed data by tagging and scoring the data based on a potential impact to a travel route. In this exemplary embodiment, each tag denotes the type of variable, a description of the possible adverse event, and a relative impact score based on how much of an impact the event may have on various travel routes (e.g., a relative impact scale using scores from 1 to 5, where 1 indicates no adverse impact and 5 indicates a large adverse impact). For example, data received from a weather feed may indicate a severe storm in the south which may adversely affect a planned travel route which passes through Atlanta, and the variable is then scored accordingly. Variables may be, for example, a service slowdown, a labor dispute, a weather prediction, the fullness of a particular flight, good seats on a flight, the on-time rating of an airport, a local event or conference (e.g., Oktoberfest in Munich), among other variables.

In step 406, travel optimization program 147 permutates the tags and scores in the genetic algorithm. The genetic algorithm is able to selectively mutate the variables obtained from the data, by using a plus one or minus one scoring methodology, based in part on the likely veracity of each variable, in order to determine the coefficients of each variable. The scoring methodology ensures that variability in the data is adequately accounted for in the output options that are determined for a user. For example, data received about a service slowdown from an airline spokesperson may be assigned a 0.9% veracity, while the same information received from a tweet may be assigned 0.5% veracity.

In step 408, travel optimization program 147 inserts the permutated scores into a standard optimization function, and the top three rated permutations are input into a final optimization calculation (based on all of the gathered data and calculations).

In step 410, the top three rated permutation outputs are fed into the remaining variables and travel optimization program 147 performs a final optimization on all of the variables. After the optimization calculations using the genetic algorithm are completed, in step 412, the subroutine returns to step 214 in FIG. 2A.

FIG. 3 is a block diagram of internal and external components of a computer system 500, which is representative of the computer systems of FIG. 1, in accordance with an embodiment of the present invention. It should be appreciated that FIG. 3 provides only an illustration of one implementation and does not imply any limitations with regard to the environments in which different embodiments may be implemented. In general, the components illustrated in FIG. 3 are representative of any electronic device capable of executing machine-readable program instructions. Examples of computer systems, environments, and/or configurations that may be represented by the components illustrated in FIG. 3 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 500 includes communications fabric 502, which provides for communications between one or more processors 504, memory 506, persistent storage 508, communications unit 512, and one or more input/output (I/O) interfaces 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media. Software (e.g., modeling program 144, travel optimization program, etc.) is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer-readable storage medium that is also part of persistent storage 508.

Communications unit 512 provides for communications with other computer systems or devices via a network (e.g., network 110). In this exemplary embodiment, communications unit 512 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computing device 140 through communications unit 512 (e.g., via the Internet, a local area network or other wide area network). From communications unit 512, the software and data can be loaded onto persistent storage 508.

One or more I/O interfaces 514 allow for input and output of data with other devices that may be connected to computer system 500. For example, I/O interface 514 can provide a connection to one or more external devices 520 such as a keyboard, computer mouse, touch screen, virtual keyboard, touch pad, pointing device, or other human interface devices. External devices 520 can also include portable computer-readable storage media such as, for example, thumb drives, portable optical or magnetic disks, and memory cards. I/O interface 514 also connects to display 522.

Display 522 provides a mechanism to display data to a user and can be, for example, a computer monitor. Display 522 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A travel expense optimization method, the method comprising:
for a set of planned travel parameters, mining, by an analytics engine, a plurality of data types;
transposing, by the analytics engine, the plurality of data types into a set of variables;
performing, by the analytics engine, a constraint-based optimization, wherein the constraint-based optimization comprises more than one constraint;
performing, by one or more processors, a genetic algorithm, wherein the genetic algorithm is based, at least in part, on a plurality of data from one or more media feeds; and
generating, by the analytics engine, a list of travel options, wherein the list of travel options is based, at least in part, on results associated with the constraint-based optimization and results associated with the genetic algorithm.

2. The method of claim 1, further comprising:
executing, by one or more processors, at least one scenario of travel expense optimization based on the list of travel options, wherein the at least one scenario of travel expense optimization excludes a subset of the plurality of data.

3. The method of claim 1, further comprising:
determining, by a policy engine, whether at least one travel exception exists, based on the results associated with the constraint-based optimization;
responsive to determining that at least one travel exception exists, approving, by the policy engine, the at least one travel exception; and
updating, by the policy engine, a predefined travel policy, based on one or more new constraints associated with the at least one travel exception.

4. The method of claim 1, wherein performing the constraint-based optimization comprises:
receiving, by the analytics engine, a set of information, wherein the set of information details more than one constraint;
applying the more than one constraint to the set of variables, based, at least in part, on a predefined travel policy and the plurality of data types; and
generating, by the analytics engine, a list of travel options, wherein the list of travel options comprise a lowest travel cost for the set of planned travel parameters.

5. The method of claim 1, wherein performing the genetic algorithm comprises:
parsing the plurality of data from the one or more media feeds into a database;
scoring the plurality of data, using a relative potential impact scale, to determine coefficients of the one or more variables; and
inserting the scored plurality of data into an optimization function.

6. The method of claim 1, wherein the set of variables comprise: a service slowdown, a labor dispute, a weather prediction, availability of seats on a particular flight, good seats on a particular flight, an on-time rating of an airport, a local event, and a local conference.

7. The method of claim 1, wherein the more than one constraint comprises: a low raw cost, a loyalty program membership, favored airports by an employee, favored travel routes by the employee, favored amenities by the employee, a role of the employee in a company, and historical travel trends of the employee.

8. A computer program product comprising:
a computer readable storage medium and program instructions stored on the computer readable storage medium, the program instructions comprising:
program instructions to, for a set of planned travel parameters, mine a plurality of data types;
program instructions to transpose the plurality of data types into a set of variables;
program instructions to perform a constraint-based optimization, wherein the constraint-based optimization comprises more than one constraint;
program instructions to perform a genetic algorithm, wherein the genetic algorithm is based, at least in part, on a plurality of data from one or more media feeds; and
program instructions to generate a list of travel options, wherein the list of travel options is based, at least in part, on results associated with the constraint-based optimization and results associated with the genetic algorithm.

9. The computer program product of claim 8, further comprising:
program instructions to execute at least one scenario of travel expense optimization based on the list of travel options, wherein the at least one scenario of travel expense optimization excludes a subset of the plurality of data.

10. The computer program product of claim 8, further comprising:
program instructions to determine whether at least one travel exception exists, based on the results associated with the constraint-based optimization;
program instructions to, responsive to determining that at least one travel exception exists, approve the at least one travel exception; and
program instructions to update a predefined travel policy, based on one or more new constraints associated with the at least one travel exception.

11. The computer program product of claim 8, wherein the program instructions to perform the constraint-based optimization comprise:
program instructions to receive a set of information, wherein the set of information details more than one constraint;
program instructions to apply the more than one constraint to the set of variables, based, at least in part, on a predefined travel policy and the plurality of data types; and
program instructions to generate a list of travel options, wherein the list of travel options comprise a lowest travel cost for the set of planned travel parameters.

12. The computer program product of claim 8, wherein the program instructions to perform the genetic algorithm comprise:
program instructions to parse the plurality of data from the one or more media feeds into a database;
program instructions to score the plurality of data, using a relative potential impact scale, to determine coefficients of the one or more variables; and
program instructions to insert the scored plurality of data into an optimization function.

13. The computer program product of claim 8, wherein the set of variables comprise: a service slowdown, a labor dispute, a weather prediction, availability of seats on a particular flight, good seats on a particular flight, an on-time rating of an airport, a local event, and a local conference.

14. The computer program product of claim 8, wherein the more than one constraint comprises: a low raw cost, a loyalty program membership, favored airports by an employee, favored travel routes by the employee, favored amenities by the employee, a role of the employee in a company, and historical travel trends of the employee.

15. A computer system comprising:
one or more computer processors;
one or more computer readable storage media;
program instructions stored on the one or more computer readable storage media for execution by at least one of the one or more processors, the program instructions comprising:
program instructions to, for a set of planned travel parameters, mine a plurality of data types;
program instructions to transpose the plurality of data types into a set of variables;
program instructions to perform a constraint-based optimization, wherein the constraint-based optimization comprises more than one constraint;
program instructions to perform a genetic algorithm, wherein the genetic algorithm is based, at least in part, on a plurality of data from one or more media feeds; and
program instructions to generate a list of travel options, wherein the list of travel options is based, at least in part, on results associated with the constraint-based optimization and results associated with the genetic algorithm.

16. The computer system of claim 15, further comprising:
program instructions to execute at least one scenario of travel expense optimization based on the list of travel options, wherein the at least one scenario of travel expense optimization excludes a subset of the plurality of data.

17. The computer system of claim 15, further comprising:
program instructions to determine whether at least one travel exception exists, based on the results associated with the constraint-based optimization;
program instructions to, responsive to determining that at least one travel exception exists, approve the at least one travel exception; and
program instructions to update a predefined travel policy, based on one or more new constraints associated with the at least one travel exception.

18. The computer system of claim 15, wherein the program instructions to perform the constraint-based optimization comprise:
program instructions to receive a set of information, wherein the set of information details more than one constraint;
program instructions to apply the more than one constraint to the set of variables, based, at least in part, on a predefined travel policy and the plurality of data types; and
program instructions to generate a list of travel options, wherein the list of travel options comprise a lowest travel cost for the set of planned travel parameters.

19. The computer system of claim 15, wherein the program instructions to perform the genetic algorithm comprise:
program instructions to parse the plurality of data from the one or more media feeds into a database;
program instructions to score the plurality of data, using a relative potential impact scale, to determine coefficients of the one or more variables; and
program instructions to insert the scored plurality of data into an optimization function.

20. The computer system of claim 15, wherein the set of variables comprise: a service slowdown, a labor dispute, a weather prediction, availability of seats on a particular flight, good seats on a particular flight, an on-time rating of an airport, a local event, and a local conference.
